(19) United States
(12) Patent Application Publication
(10) Pub. No.: US 2014/0003463 A1
(43) Pub. Date: Jan. 2, 2014

(54) NON-CONTACT THERMOMETER

(71) Applicants: Patrick Jackson, Warwick, RI (US); Timothy Johnson, Boston, MA (US); Ralf Oliver Schneider, Boston, MA (US); Shankar M. Krishnan, Boston, MA (US); Ross B. Kaplan, Sharon, MA (US)

(72) Inventors: Patrick Jackson, Warwick, RI (US); Timothy Johnson, Boston, MA (US); Ralf Oliver Schneider, Boston, MA (US); Shankar M. Krishnan, Boston, MA (US); Ross B. Kaplan, Sharon, MA (US)

(21) Appl. No.: 13/538,446

(22) Filed: Jun. 29, 2012

(51) Int. Cl. G01J 5/00

(52) U.S. Cl. 374/121

(57) ABSTRACT

A device for detecting infrared radiation emanating from a subject while not in physical contact with the subject is disclosed. The device includes a handle, a yoke having at least two yoke arms, which define a well there-between, and an infrared radiation sensor. The infrared radiation sensor is located in the well and oriented to receive the infrared radiation.

### BACKGROUND

1. Technical Field

The present invention generally relates temperature sensing devices, and more particularly to non-contact thermometers.

2. Description of Related Art

An infrared (IR) or thermal radiation thermometer or measures infrared radiation from an object and can determine temperature without physically contacting the object. Such thermometers are also referred to as “non-contact” or “remote” thermometers. In operation, IR thermometers detect an intensity of IR radiation from a surface of an object whose temperature is desired. From the intensity of infrared radiation, the temperature can be computed. For example, an IR thermometer typically includes an IR sensor or detector that detects IR radiation, which can be converted into an electrical signal suitable for processing by conventional electronic circuits (e.g. a processor).

It is important to direct or align the IR sensor with a radiation surface of the object so that the IR sensor can adequately receive IR radiation from the object. Such alignment minimizes detection of additional ambient environmental radiation. For certain applications, the IR sensor is directed toward a particular portion of the surface of the object when, for instance, the radiation across the surface is subject to variation. In these instances, directing the sensor toward the particular portion of the surface minimizes discrepancy in detected IR radiation from other areas of the surface.

Conventional devices that provide alignment assistance for a user to direct the IR sensor toward an object provide complex and expensive designs. For example, some conventional devices provide light emitting diodes (LEDs) that project a particular pattern of light that on the surface of the object when the IR sensor is properly aligned (e.g., two projected dots that converge when the IR sensor is properly aligned). However, such designs are complex and require additional electronic circuitry to ensure that the LED(s) are properly configured to provide such a pattern.

Accordingly, despite efforts to date, improvements are needed for non-contact thermometers to provide simplified alignment mechanisms so as to direct an IR sensor toward a surface (or portions thereof) for an object to detect thermal radiation therefrom.

### SUMMARY

The invention generally relates to improved alignment techniques that direct an infrared sensor toward a surface of an object, including portions thereof. The improved alignment techniques facilitate thermal radiation detection emanating from an object or a subject (e.g., a human). The detected radiation can then be used in further analyses.

In accordance with one aspect of the disclosure, a device can detect infrared radiation emanating from a subject while not in physical contact with the subject. The device includes a handle and a yoke integral to the handle. The yoke can include at least two yoke arms, with the yoke arms defining a well there-between. In preferable embodiments, the yoke arms are located on opposing sides of the yoke. The device further includes an infrared radiation sensor located in the well, which can be oriented to receive the infrared radiation from the subject. In this fashion, the well facilitates alignment of the device according to a predetermined feature of the subject (e.g., aligning the well with a bridge of the nose of the subject). Notably, the infrared radiation sensor can be fixed, or, in some embodiments, the infrared radiation sensor can be adjustable according to a distance between the device and the subject.

In addition, in certain embodiments, the yoke arms can be configured to align the device with a predetermined portion of the subject. For example, the predetermined portion of the subject can include, in the case of the subject being a human, outer corners of the human's eyes. Moreover, the yoke arms can be configured to align the device with an alignment plane defined by the two yoke arms and at least one point within the region between the outer corners of the human patient's eyes. In these embodiments, the infrared radiation sensor can receive infrared radiation from the human patient along a direction defined at least in part by a radiation plane that intersects the alignment plane at a predetermined angle and includes at least a first point defined by a location of the radiation sensor and one or more points defined in a forehead region of the human patient.

In certain other embodiments, the device can include a power source, at least one switch, and a processor, both the switch and the processor can be in communication with the power source. The switch can turns the device on and off and/or perform a trigger function that permits the infrared radiation sensor to receive infrared radiation. The processor can computes a temperature of the subject based at least in part on data received from the infrared radiation sensor. Preferably, the device can include a display in communication with the processor which can be configured to render a representation of the temperature of the subject (e.g., a numerical readout of the temperature).

In additional embodiments, the device can further include a transmitter in communication with the processor. The transmitter can be configured to send at least the temperature of the subject to a remote location (e.g., a remote processing system) for additional analyses. The transmitter can send this temperature either wirelessly or via a hardwired connection.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a perspective view of a first representative embodiment of a non-contact thermometer device constructed in accordance with the present disclosure;

FIG. 2 is a front-side view of the non-contact thermometer device of FIG. 1;

FIG. 3 is a left-side view of the non-contact thermometer device of FIG. 1;

FIG. 4 is a back-side view of the non-contact thermometer device of FIG. 1;

FIG. 5 is a top-side view of the non-contact thermometer device of FIG. 1;

FIG. 6 is a perspective view of another exemplary embodiment of a non-contact thermometer device, showing an adjustable infrared radiation sensor;

FIG. 7 is a schematic view of a system, showing one example alignment of a non-contact thermometer with a subject according to the present disclosure;

FIG. 8 is a top schematic view of the system of FIG. 7; and

FIG. 9 is a schematic view of a system, showing wireless transmission of radiation data to a remote location.

### DESCRIPTION

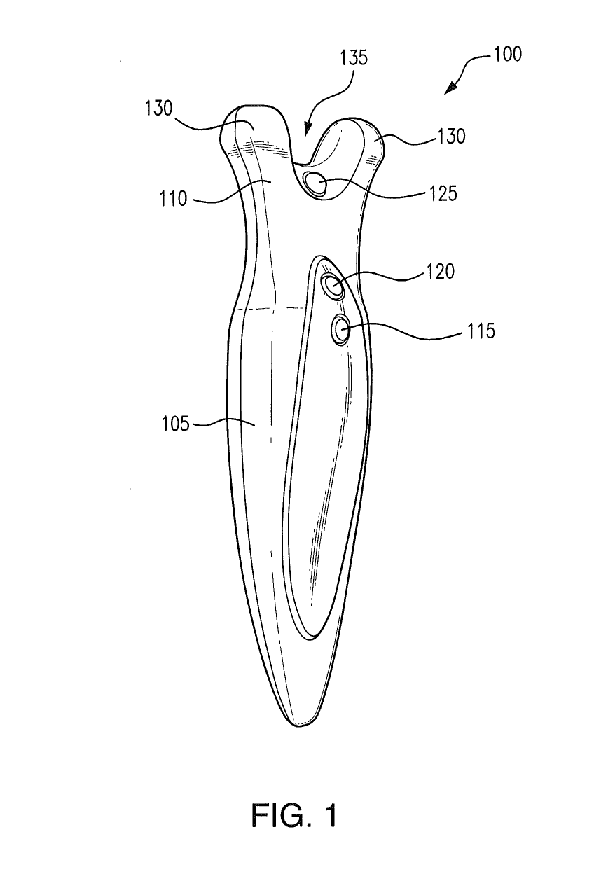

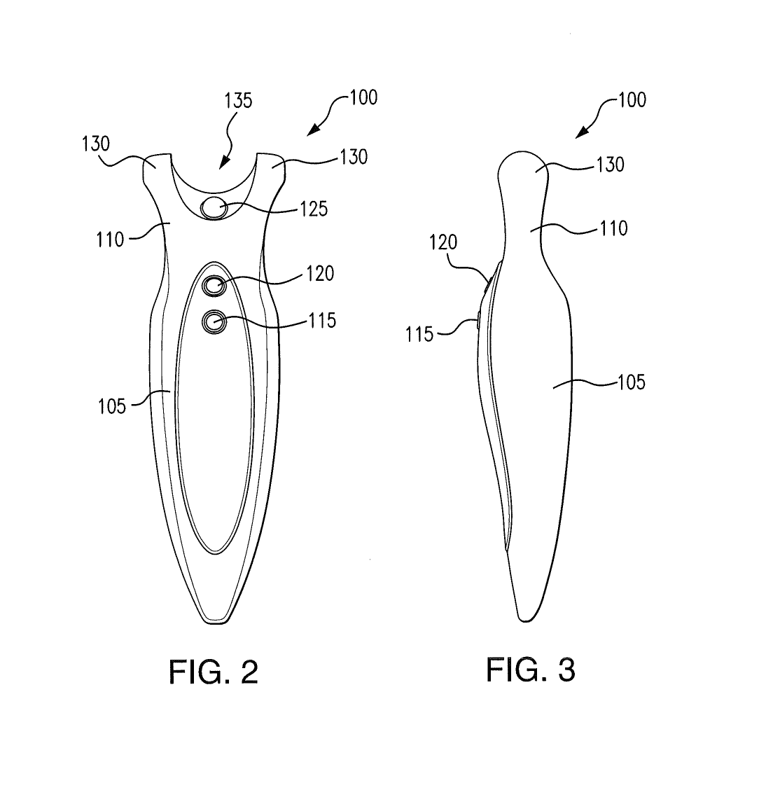

Reference will now be made to the drawings wherein like reference numerals identify similar structural features or aspects of the subject invention. For purposes of explanation and illustration, and not limitation, a perspective view of an exemplary embodiment of a non-contact thermometer device in accordance with the invention is shown in FIG. 1 and is designated generally by reference character 100. Other views and various other embodiments of non-contact thermometer devices in accordance with the invention, or aspects thereof, are provided in FIGS. 2-7, as will be described herein. The devices and methods of the invention can be used for remote detection of temperature of a subject, or in any other suitable application, for enhanced non-contact temperature detection.

As shown in FIG. 1, a perspective view of a non-contact thermometer device 100 is illustrated. Device 100 includes a handle portion 105, a yoke portion 110, two buttons—namely button/switch 115 and button/switch 120—and an infrared (IR) sensor 125. Yoke portion 110 includes two yoke arms 130, which define a well 135 located there-between. As illustrated, yoke portion 110 is formed integral to handle 105, and yoke arms 130 are located on opposing sides of the yoke portion 110. In other embodiments, however, yoke portion 110 can be constructed as separate piece, which can be joined or connected to handle 105.

Device 100 includes a power source (not shown) in communication with one or both buttons to turn the device on/off. Operatively, device 100 can for example, be powered on or off via button 115. In addition, in some embodiments, a second button (e.g., button 120) can operate as a trigger button to enable IR sensor 125 to receive radiation. Device 100 is typically aligned with a subject (or a predetermined portion of the subject) according to yoke arms 130. For example, as discussed in further detail below, yoke arms 130 can be aligned with a portion of the subject such as the pupils, where each yoke arm aligns with one pupil. In preferable embodiments, well 130 facilitates alignment of device 100 according to a predetermined feature of the subject such as, for example, a bridge of the nose of the subject. Once yoke arms 130 and/or well 130 are aligned with corresponding portions of the subject, an operator can press button 120 to trigger IR sensor 125 to receive radiation from the subject.

Referring now to FIG. 2, a front-side view of the non-contact thermometer device of FIG. 1 is illustrated. As discussed below, IR sensor 125 is positioned in well 135 and configured to receive radiation along a direction defined at least in part by a radiation plane. The radiation plane can include a point defined by a location of the IR sensor 125 and a second predetermined portion of the subject. For example, the radiation plane can include a point on the subject such as a forehead and the point or location of IR sensor 125. The radiation plane is discussed in greater detail below and with particular reference to FIG. 8.

Referring now to FIG. 3, a left-side view of the non-contact thermometer device of FIG. 1 is illustrated. Preferably, device 100 is curved so as to provide a comfortable and ergonomic grip for the user.

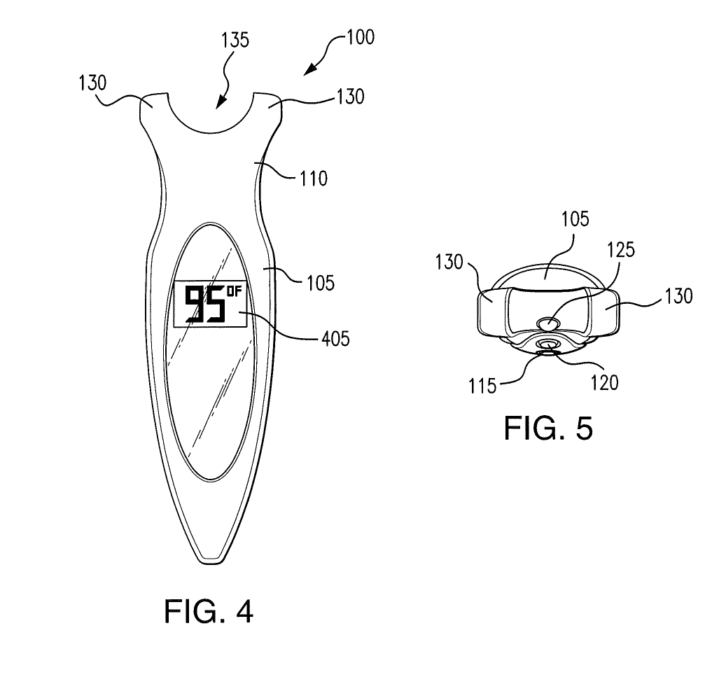

Referring to FIG. 4, a back-side view of the non-contact thermometer device 100 of FIG. 1 is illustrated. As shown, device 100 can include a display 405 that displays a temperature, which is a digital representation of the measured radiation received by IR sensor 125. Typically, device 100 includes a processor (not shown) in communication with both a power source and the IR sensor 125. The processor, in communication with IR sensor 125 can determine or calculate a representative temperature from the radiation received by IR sensor 125. The processor can further provide this information to be displayed to the user via display 405. As appreciated by those skilled in the art, the processor can be embedded in a package with the IR sensor, or alternatively, a remote processor can be provided and configured to communicate with IR sensor. As shown in FIG. 4, the temperature is represented as a measure of degrees Fahrenheit. However, in various other embodiments, the temperature can be represented in any number of temperature scales (e.g., Celsius, Kelvin, etc.).

Referring now to FIG. 5, a top-side view of the non-contact thermometer device 100 of FIG. 1 is illustrated. As shown in this view, handle 105 has a circular shape and yoke portion (as illustrated by yoke arms 130) has a rectangular shape. As shown in this embodiment, yoke arms 130, including yoke portion 110, is formed integral to handle 105. As discussed above, in various other embodiments, yoke portion 110 can be a separate construction and joined or connected to handle 105.

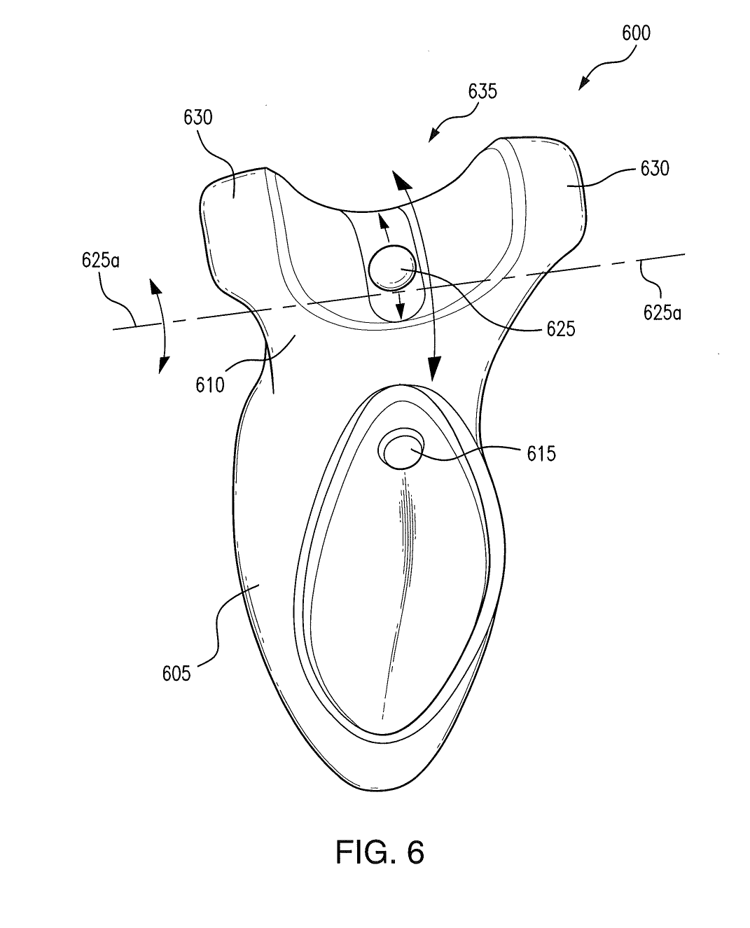

Referring now to FIG. 6, a perspective view of another exemplary embodiment of a non-contact thermometer device 600 is illustrated. Device 600 includes a handle 605, a yoke portion 610 having two yoke arms 630, a button/switch 615, and an IR sensor 625. Similar to device 100, yoke arms 630 have a well 635 defined there-between. Importantly, sensor 625 is adjustable and can rotate in the direction of the illustrated arrows about axis line 625a. As shown, sensor 625 can rotate along a track formed about axis 625a, and/or the sensor 625 can be affixed to the track, which can rotate about axis 625a. Moreover, as appreciated by those skilled in the art, rotation or adjustment of sensor 625 can also be achieved by, for example, a circular assembly whereby sensor 625 is affixed to a rotating circular assembly (e.g., a wheel-type mechanism) that can rotate about axis 625a and adjust sensor 625.

Operatively, sensor 625 can be adjustable according to a distance between device 600 and a subject. For example, device 600 can be aligned with a subject (or a predetermined portion of the subject) according to yoke arms 630. As discussed in further detail below, yoke arms 630 can be aligned with a predetermined portion of the subject such as a region between the outer corners of the subjects eyes (e.g., the pupils of the subject). Alignment of yoke arms 630 and the region of the subject define an alignment plane. In addition, depending on a distance between device 600 and the subject, sensor 625 can be adjusted about axis 625a to direct sensor 625 to a point defined in a radiation region of the subject (e.g., a forehead of the subject) in accordance with a radiation plane. The alignment plane is defined by yoke arms 630 and the region of the subject, as discussed above. However, the radiation plane is defined at least in part by the location (or point) of sensor 625 and a second point in the desired radiation region of the subject (e.g., a point on the forehead of the subject). In addition, the radiation plane intersects the alignment plane at a predetermined angle (theta). Once aligned with the radiation region (or point(s) in the radiation region) of the subject, an operator can press button 615 to trigger sensor 625 to receive radiation from the subject along the direction defined at least in part by a radiation plane. Notably, in some embodiments, device 600 can constantly receive radiation and thus will not need a trigger to begin operation.

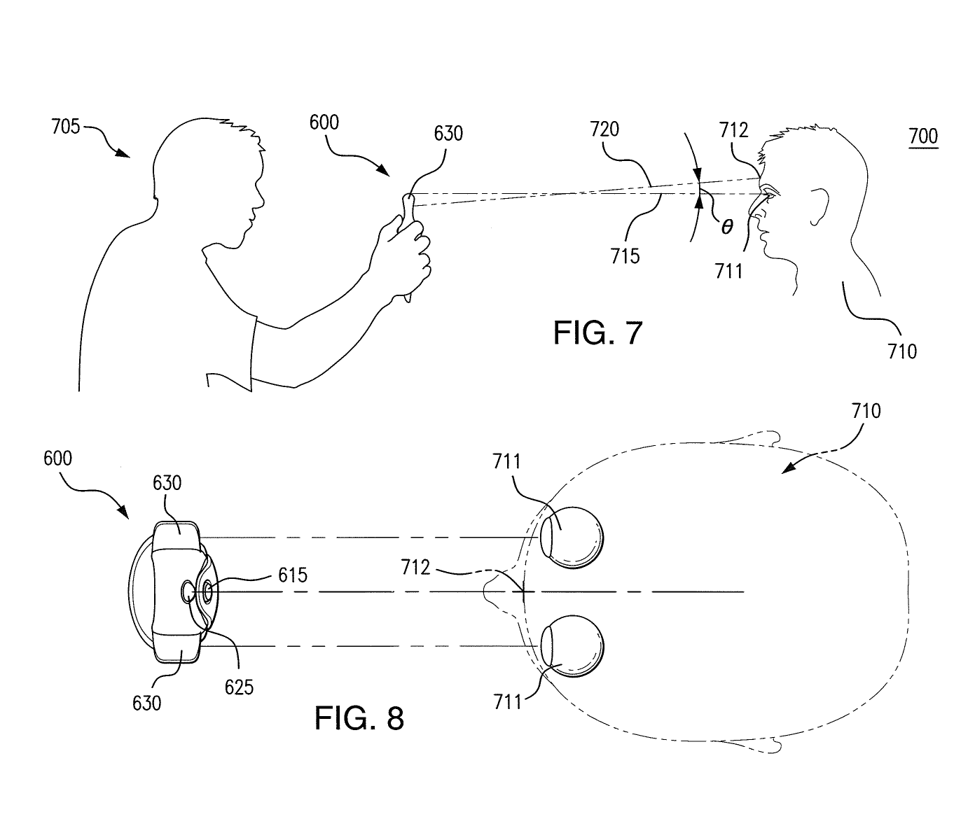

Referring now to FIG. 7, a schematic view of a system 700 is illustrated. System 700 shows one example alignment of device 600 according to an alignment plane and a radiation plane, which are illustrated as line 715 and line 720, respectively (since this is a side elevation view planes are illustrated as lines). Operatively, a user 705 aligns device 600 according to yoke arms 630 and at least one predetermined portion of a subject 710, according to an alignment plane. As shown, device 600 is aligned with a region between the outer corners of the subject's eyes 711 (e.g., pupils) according to alignment plane 715. As discussed above, infrared radiation sensor 625 receives infrared radiation from subject 720 along a direction defined at least in part by a radiation plane 720, which intersects the alignment plane 715 at a predetermined angle (theta). Radiation plane 720 is further defined at least in part by the location (or point) of sensor 625 and a second point defined in a predetermined radiation region of subject 710—here this point is illustrated as a point in the forehead portion 712 of subject 710. As discussed above, radiation sensor 625 is adjustable about axis 625a according to distance d. That is, as the distance increases or decreases, sensor 625 can be adjusted or rotated about axis 625a, which further increases or decreases the intersection angle (theta) measured between radiation plane 720 and alignment plane 715. In this fashion, sensor 625 is adjustable according to the distance so as to continue to receive radiation from the predetermined point or portion of subject 710. Notably, the view shown in FIG. 7 is for illustration and not to be read as limiting the present disclosure. For example, as appreciated by those skilled in the art, various other embodiments of non-contact thermometers (e.g., device 100) discussed herein can be used in the same fashion as device 600 is used in accordance with system 700.

Referring now to FIG. 8, a top schematic view of system 700 of FIG. 7 is illustrated. In particular, this view shows alignment of device 700 with predetermined portions of subject 710. In particular, yoke arms 630 are aligned according to a portion of subject 710 between the outer corners of eyes 711 of subject 710—here, the pupils of eyes 711, and sensor 625 is aligned with a point in the forehead portion 712 of subject 710.

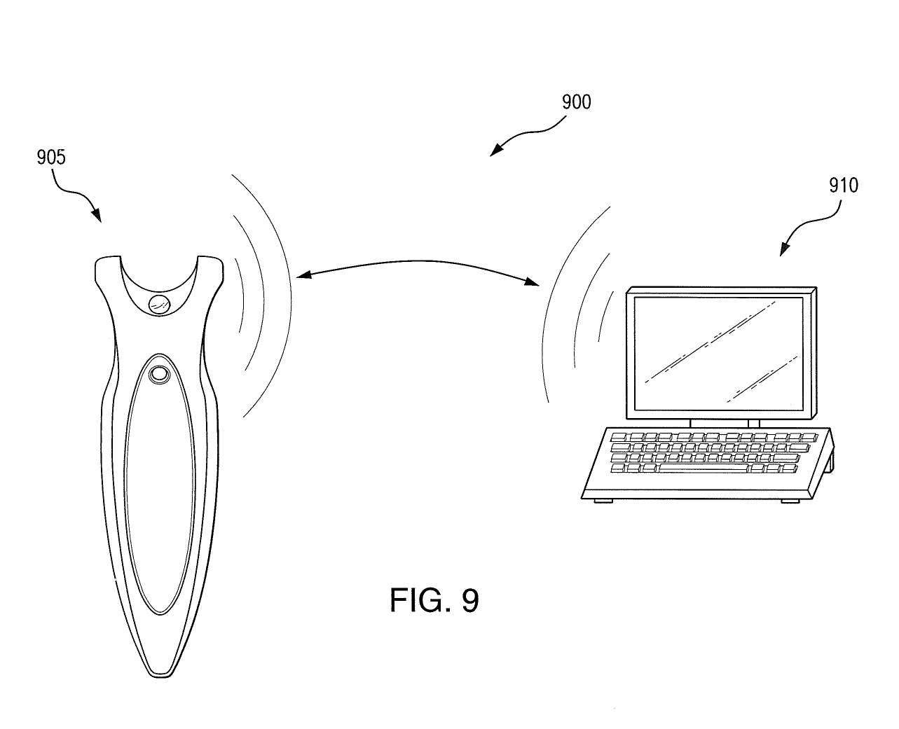

Referring now to FIG. 9, a schematic view of a system 900 is illustrated. System 900 shows a non-contact thermometer device 905 wirelessly transmitting and receiving information from a remote computer system 910. In particular, device 905 can transmit radiation data and receive data (e.g., configuration data). For example, configuration data can cause device 905 to turn on/off, receive further radiation data, display radiation data in various other scales, etc. The radiation data received by system 910 can be further processed for additional analyses such as errors, historical trends of a subject, historical trends of various subjects, etc. Notably, system 910 is shown as a computer, but it is not limited to such. System 910 can include any number of computational devices and further can include any supporting network devices such as routers, switches, etc.

While there have been shown and described illustrative embodiments that provide for non-contact thermometers, it is to be understood that various other adaptations and modifications may be made within the spirit and scope of the embodiments herein.

For example, the embodiments have been shown and described herein with relation to a human subject. However, the embodiments in their broader sense are not as limited, and may, in fact, be used with other types of subjects that provide infrared radiation (e.g., animated objects such as dogs, cats, mice, or inanimate objects such as electrical systems). In addition, while certain arrangements of buttons and sensors are shown, other suitable arrangements may be used, accordingly. Also, while the techniques generally describe particular steps for alignment of non-contact thermometers with a subject, the ordering of alignment steps may be employed to perform these steps in various combinations without departing from the spirit and scope of this disclosure.

The foregoing description has been directed to specific embodiments. It will be apparent, however, that other variations and modifications may be made to the described embodiments, with the attainment of some or all of their advantages. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A device for detecting infrared radiation emanating from a subject while not in physical contact with the subject, the device comprising:
a handle;
a yoke integral to the handle and having at least two yoke arms, the yoke arms defining a well there-between; and
an infrared radiation sensor located in the well and oriented to receive the infrared radiation.

2. The device of claim 1, wherein the yoke arms are configured to align the device with a predetermined portion of the subject.

3. The device of claim 1, wherein the infrared radiation sensor is adjustable according to a distance between the device and the subject.

4. The device of claim 1, wherein the yoke arms are located on opposing sides of the yoke.

5. The device of claim 1, wherein the well facilitates alignment of the device according to a predetermined feature of the subject.

6. The device of claim 2, wherein the subject is a human patient and the predetermined portion of the subject comprises a region between the outer corners of the human patient's eyes.

7. The device of claim 6, wherein the yoke arms are configured to align the device with an alignment plane defined by the two yoke arms and at least one point within the region between the outer corners of the human patient's eyes.

8. The device of claim 7, wherein the infrared radiation sensor receives infrared radiation from the human patient along a direction defined at least in part by a radiation plane that intersects the alignment plane at a predetermined angle and includes at least a first point defined by a location of the radiation sensor and a second point defined in a forehead region of the human patient.

9. The device of claim 1, further comprising:
a power source; and
a switch in communication with the power source that turns the device on and off.

10. The device of claim 9, further comprising a processor in communication with the power source and the infrared radiation sensor.

11. The device of claim 10, wherein the processor computes a temperature of the subject based at least in part on data received from the infrared radiation sensor.

12. The device of claim 10, further comprising a display in communication with the processor, the display configured to render a representation of the temperature of the subject.

13. The device of claim 12, wherein the representation of the temperature of the subject comprises a numerical readout of the temperature.

14. The device of claim 11, further comprising a transmitter in communication with the processor, the transmitter configured to send at least the temperature of the subject to a remote location.

15. The device of claim 14, wherein the transmitter sends the temperature of the subject wirelessly.

16. A device for detecting infrared radiation emanating from a subject while not in physical contact with the subject, the device comprising:
a handle;
a yoke integral to the handle and having at least two yoke arms, the yoke arms defining a well therebetween and configured to align the device with an alignment plane defined by the two yoke arms and at least one point defined in a first predetermined portion of the subject; and
an infrared radiation sensor located in the well and oriented to receive the infrared radiation along a direction defined at least in part by a radiation plane that intersects the alignment plane at a predetermined angle and includes a point defined by a location of the radiation sensor.

17. The device of claim 16, wherein the radiation plane is further defined by a point in a second predetermined portion of the subject.

18. The device of claim 16, further comprising:
a power source; and
a switch in communication with the power source that turns the device on and off.

19. The device of claim 18, further comprising:
a processor in communication with the power source and the infrared radiation sensor, wherein the processor computes a temperature of the subject based at least in part on data received from the infrared radiation sensor; and
a display in communication with the processor, the display configured to render a representation of the temperature of the subject.

20. The device of claim 16, wherein the infrared radiation sensor is adjustable according to a distance between the device and the subject.

21. The device of claim 20, further comprising:
a trigger switch that permits the infrared radiation sensor to receive infrared radiation.
